(19) United States
(12) Patent Application Publication
(10) Pub. No.: US 2022/0180821 A1
(43) Pub. Date: Jun. 9, 2022

(54) ILLUMINATING LIQUID CRYSTAL DISPLAYS USING OVERLAPPING LOCAL DIMMING ZONES

(71) Applicant: Hewlett-Packard Development Company, L.P., Spring, TX (US)

(72) Inventors: Hsing-Hung Hsieh, Taipei City (TW); Super Liao, Taipei City (TW); Cheng-Hua Yu, Taipei City (TW)

(73) Assignee: Hewlett-Packard Development Company, L.P., Spring, TX (US)

(21) Appl. No.: 17/435,412

(22) PCT Filed: Jul. 19, 2019
(86) PCT No.: PCT/US2019/042567

§ 371 Date: Sep. 1, 2021

(51) Int. Cl. G09G 3/34; G09G 3/36

(52) U.S. Cl. CPC G09G 3/342; G09G 3/36; G09G 2320/0626; G09G 2340/14; G09G 2310/08

(57) ABSTRACT

In an example method, a liquid crystal display (LCD) is illuminated using a first number of local dimming zones. A second number of local dimming zones that overlap the first number of local dimming zones is determined. The LCD is illuminated using the second number of local dimming zones.

### BACKGROUND

Light emitting diodes (LEDs) are used to illuminate liquid crystal displays (LCDs). For example, the LEDs may be arranged into zones.

### BRIEF DESCRIPTION OF THE DRAWINGS

Various features of the techniques of the present application will become apparent from the following description of examples, given by way of example only, which is made with reference to the accompanying drawings, of which:

FIG. 1A is a schematic diagram of an example LCD display at a first time illuminated using a first number of local dimming zones;

FIG. 1B is a schematic diagram of an example LCD display at a second time illuminated using a second number of local dimming zones that overlap the first number of local dimming zones;

FIG. 2 is a process flow diagram illustrating an example method for illuminating liquid crystal displays using overlapping local dimming zones;

FIG. 3 is block diagram of an example display device to be illuminated using local dimming zones that overlap over time; and

FIG. 4 is a drawing of an example machine-readable storage medium that can be used to generate overlapping numbers of local dimming zones.

### DETAILED DESCRIPTION

LCDs may be illuminated using LEDs arranged into local dimming zones to provide increased contrast by varying illumination depending on the content being displayed in each local dimming zone. For example, local dimming zones with lots of shadows may be dimmed in order to provide for darker shadows. In those zones with dimmer LED brightness, the off state brightness is also dimmer. Similarly, local dimming zones including bright highlights may be kept at full brightness in order to provide for brighter highlights. In this way, the contrast between the brightest highlight and the darkest shadow may be increased to provide an improved dynamic range. However, LEDs may lose their brightness over time based on how much power is used to drive them. Thus, LEDs used in local dimming zones that contain highlights for greater periods of time than other local dimming zones may gradually appear darker than other local dimming zones in which the LEDs are dimmed for longer periods of time. For example, a particular zone may include a logo that is displayed on an LCD for extended periods of time, resulting in the corresponding local dimming zone to be brighter than other local dimming zones for extended periods of time. Thus, for this reason, the use of the same number of local dimming zones may result in bands of unevenly illuminated portions of an LCD.

Described herein are techniques for illuminating LCDs using overlapping local dimming zones. As used herein, an overlapping local dimming zone refers to a local dimming zone that overlaps a previously used local dimming zone. For example, a number of local dimming zones that is mutually prime with a previous number of local dimming zones may not share any common edges with the previous number of local dimming zones. For example, the numbers of local dimming zones may be mutually prime. As used herein, two numbers are mutually prime refers if the only positive integer or factor that divides both of them is 1. Thus, the LCDs may be illuminated using a series of mutually prime numbers of local dimming zones.

Thus, the techniques described herein enable the usage of LEDs to be more evenly distributed across local dimming zones. More evenly distributed usage of LEDs may accordingly prevent bands of unevenly illuminated portions of an LCD from forming. In this way, the techniques enable local dimming zones to be used to improve dynamic range in LCDs without resulting in bands of panel non-uniformity associated with the use of a single set of static local dimming zones. Using the techniques described herein, even if the non-uniformity issue occurs, the zone edges may be less obvious to the users resulting in less visual impact. In addition, in some examples, zone numbers can be switched depending on content. In this way, the techniques may be helpful to balance image quality and panel power consumption, because more zones means better contrast but higher power consumption.

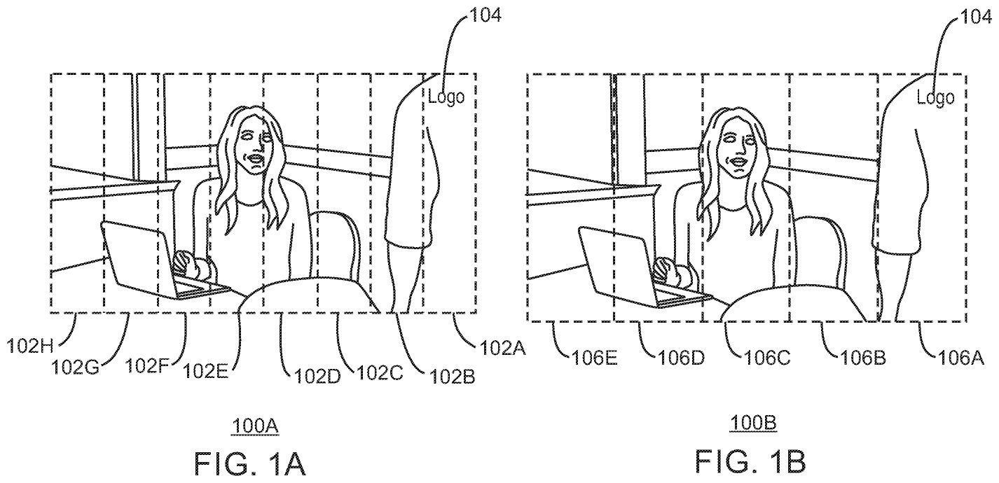

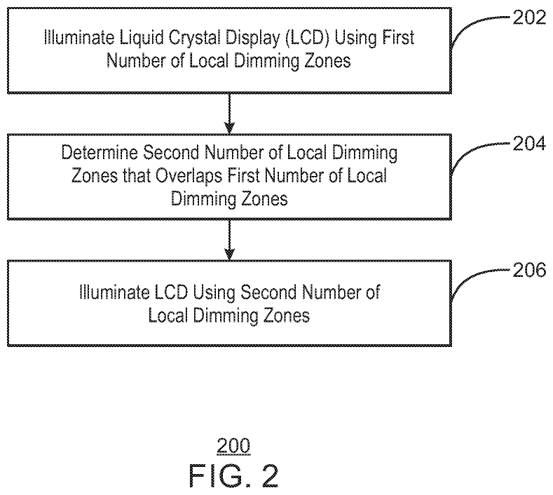

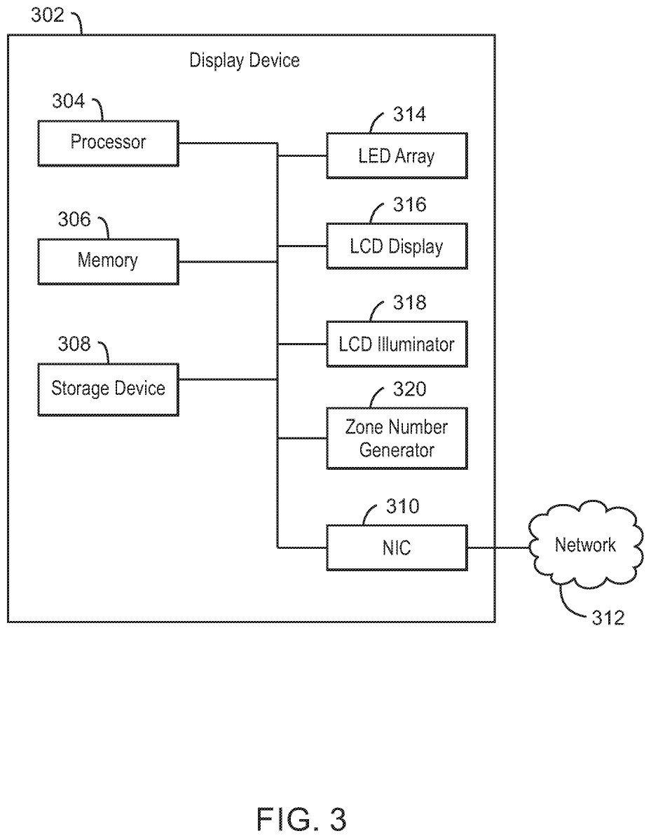

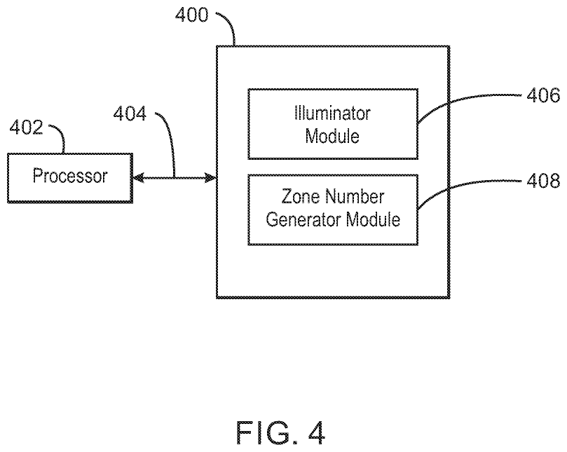

FIG. 1A is a schematic diagram of an example LCD display at a first time illuminated using a first number of local dimming zones. The example LCD display 100 may be generated using the method 200 of FIG. 2 or the computer readable-media 400 of FIG. 4 via the display device 300 of FIG. 3.

The LCD display 100A includes eight local dimming zones 102A-102H. The LDC display 100A further includes a logo 104.

In the example LCD display 100A, the logo 104 may be brightly displayed. For example, the logo may be a bright white logo. Thus, the local dimming zone 102A may be brighter than local dimming zones 102B-102H because of the constantly present logo 104. For example, local dimming zones 102G and 102H may be dimmed significantly to display shadows with less light resulting from light leakage of liquid crystals. In various examples, the number of local dimming zones may then change to an overlapping number of local dimming zones, as discussed in FIG. 1B. For example, the number of local dimming zones may be changed after a predetermined amount of time. In some examples, a new number of local dimming zones may be determined after the predetermined amount of time. For example, the number of local dimming zones may be determined at regular intervals of a predetermined number of minutes. In various examples, a new number of local dimming zones may be determined in response to detecting a change in content being displayed. For example, a smaller or larger portion of the screen may be displaying brighter or darker content. In various examples, the number of local dimming zones may be based on the content. For example, more or less zones may be used to fit the dynamic range to be displayed for the content. In some examples, the local dimming zones may be cycled through a static list of predetermined local dimming zones at regular intervals of time.

The schematic diagram of FIG. 1A is not intended to indicate that the example LCD display 100A is to include all of the components shown in FIG. 1A. Further, the LCD display 100A may include any number of additional components not shown in FIG. 1A, depending on the details of the specific implementation. For example, FIG. 1A may include less or additional local dimming zones, logos, or different content displayed.

FIG. 1B is a schematic diagram of an example LCD display at a second time illuminated using a second number of local dimming zones that overlap the first number of local dimming zones. The example LCD display 100B may be generated using the method 200 of FIG. 2 or the computer readable-media 400 of FIG. 4 via the display device 300 of FIG. 3. For example, the LCD display 100B may be the LCD display 100A at a later point in time.

The LCD display 100B includes five local dimming zones 106A-106E. The LDC display 100B further also includes the logo 104.

In the example LCD display 100B, the total number of local dimming zones 106A-106E is five. As shown in FIG. 1B, the edges of the five local dimming zones 106A-106E do not coincide with any of the edges of the eight local dimming zones 102A-102H of FIG. 1. The local dimming zones of FIG. 1A and FIG. 1B may thus be described as overlapping. In some examples, any other mutually prime number to eight may instead be used for the total number of local dimming zones in LCD display 100B. For example, three, seven, nine, ten, eleven local dimming zones may instead be used in LCD display 100B to follow the local dimming zones of LCD display 100A.

By using overlapping, or mutually prime, numbers of local dimming zones in series, a display device may thus spread out the higher used LEDs of previous local dimming zone 102A with additional LEDs in local dimming zone 106A and thereby reduce the difference in usage of adjacent LEDs. In this way, visible bands of unevenly used local dimming zones may be prevented and the quality of the display device picture may thus be prevented from degrading over time.

The schematic diagram of FIG. 1B is not intended to indicate that the example LCD display 100B is to include all of the components shown in FIG. 1B. Further, the LCD display 100B may include any number of additional components not shown in FIG. 1B, depending on the details of the specific implementation. For example, FIG. 1B may include less or additional local dimming zones, logos, or different content displayed.

FIG. 2 is a process flow diagram illustrating an example method for illuminating liquid crystal displays using overlapping local dimming zones. The method 200 of FIG. 2 can be implemented using the method 200 of FIG. 2 in the display device 300 of FIG. 3. For example, the method may be implemented using processor 304.

At block 202, a liquid crystal display (LCD) is illuminated using a first number of local dimming zones. For example, the local dimming zones may be dimmed based on the content being displayed at each of the local dimming zones. For examples, local dimming zones containing shadows may be dimmed to reduce the amount of light in the darkest shadows.

At block 204, a second number of local dimming zones that overlap the first number of local dimming zones is determined. For example, the second number may be mutually prime with respect to the first number. In various examples, determining the second number may include randomly switching to a number of a list of mutually prime numbers. In some examples, zone numbers are periodically switched in a predetermined order and a predetermined time interval. In various examples, the second number of local dimming zones may be based on content being displayed on the LCD.

At block 206, the LCD is illuminated using the second number of local dimming zones. For example, the LCD may be illuminated with a number of local dimming zones with edges that do not correspond to any of the edges of the first number of local dimming zones. In various examples, the second number of dimming zones may similarly be dimmed based on content to be displayed at each of the local dimming zones.

It is to be understood that the process diagram of FIG. 2 is not intended to indicate that all of the elements of the method 200 are to be included in every case. Further, any number of additional elements not shown in FIG. 2 may be included in the method 200, depending on the details of the specific implementation. For example, the method may include determining a series of additional numbers of overlapping local dimming zones and illuminating the LCD using the series of additional numbers of overlapping local dimming zones. In some examples, the method 200 may include periodically switching zone numbers in a predetermined order and a predetermined time interval. In various exempts, the method 200 may also include switching zone numbers based on content to be displayed. In some examples, the method 200 may also further include dynamically changing a brightness of each of the dimming zones to match a brightness level for content appearing in each of the dimming zones.

FIG. 3 is a block diagram of an example display device 302 to be illuminated using local dimming zones that overlap over time. For example, the display device 302 may be a smart television, or a computer monitor. In various examples, the display device 302 is a high dynamic range (HDR) display device. The display device 302 may include a processor 304, memory 306, a machine-readable storage 308, and a network interface 310 to connect display device 302 to network 312. For example, the network interface 310 can be a network interface card (NIC).

In some examples, the processor 304 may be a main processor that is adapted to execute the stored instructions. Moreover, more than one processor 304 may be employed. Further, the processor 304 may be a single core processor, a multi-core processor, a computing cluster, or any number of other configurations. The processor 304 may be implemented as Complex Instruction Set Computer (CISC) or Reduced Instruction Set Computer (RISC) processors, x86 Instruction set compatible processors, ARMv7 Instruction set compatible processors, multi-core, or any other microprocessor or central processing unit (CPU).

The memory 106 may be a memory device. The memory 106 may be volatile memory or nonvolatile memory. In some examples, the memory 306 may include random access memory (RAM), cache, read only memory (ROM), flash memory, and other memory systems.

The storage device 308 is machine-readable storage and may include volatile and nonvolatile memory. In some examples, the storage device 308 may be electronic, magnetic, optical, or other physical storage device that stores executable instructions (e.g., code, logic). Thus, the storage device 308 may be, for example, RAM, an Electrically-Erasable Programmable Read-Only Memory (EEPROM), a storage drive such as a hard drive or solid state drive (SSD), an optical disc, and the like. The storage device 308 may also include storage or memory external to the display device 302. Moreover, as described herein, the storage device 308 may be encoded with executable instructions (e.g., executed by the processor 304) for generating numbers of local dimming zones. For example, the storage device 308 may be encoded with executable instructions for generating overlapping numbers of local dimming zones.

In some examples, a network interface 310 (e.g., a network interface card or NIC) may couple the display device 302 to a network 312. For example, the network interface 310 may connect display device 302 to a local network 312, a virtual private network (VPN), or the Internet. In some examples, the network interface 310 may include an Ethernet controller.

The display device 302 also includes an LED array 314. For example, the LED array 314 may include a number of LEDs. In various examples, the LEDs may be arranged in a row along a panel edge of the display device 302. In some examples, the LED array 314 may be coupled to a light guide plate. For example, the light guide plate may include a number of light guides to guide light from each of the LEDs in the LED array 314 in the vertical direction across the display device 302. Thus, a single LED of the LED array 314 may provide illumination to a column of the display device 302. In various examples, the LED array 314 may be grouped into alternating numbers of overlapping local dimming zones, as described herein. For example, each of the local dimming zones may include a particular number of LEDs and associated light guides.

The display device 302 also includes an LCD display 316. For example, the LCD display 316 is illuminated using a number of local dimming zones. In various examples, the number of the local dimming zones may be modified over time to other mutually prime numbers. For example, the number of local dimming zones may be generated as described herein. In some examples, the numbers of local dimming zones may be received in a predetermined list of mutually prime numbers.

The display device 302 may also include an LCD illuminator 318. The LCD illuminator 318 may drive a plurality of light emitting diodes (LEDs) of the local dimming zones. For example, each of the local dimming zones may include a subset of the plurality of LEDs. The LCD illuminator 318 can receive a number of local dimming zones to use from a zone number generator 320. The LCD illuminator 318 can drive a plurality of light emitting diodes (LEDs) of the local dimming zones. In various examples, the LCD illuminator 318 can dynamically modify a brightness of each of the local dimming zones to match a brightness level for content appearing in each of the local dimming zones.

The zone number generator 320 can generate a series of alternating numbers of overlapping local dimming zones. For example, the alternating numbers of overlapping local dimming zones are mutually prime. In some examples, the zone number generator 320 can randomly switch to a number of a list of mutually prime numbers of local dimming zones. In various examples, the zone number generator 320 can periodically switching zone numbers in a predetermined order and a predetermined time interval. In some examples, the zone number generator 320 can switch to different numbers of local dimming zones based on content to be displayed on the LCD.

The LCD illuminator 318 and zone number generator 320 may be instructions (e.g., code, logic, etc.) store in the storage device 308 and executed by the processor 304 or other processor to direct the computing device 300 to implement the aforementioned actions. An application-specific integrated circuit (ASIC) may also be employed. In other words, an ASIC may be customized for the aforementioned actions implemented via the LCD illuminator 318 and zone number generator 320.

The block diagram of FIG. 3 is not intended to indicate that the display device 302 is to include all of the components shown in FIG. 3. For example, the display device 302 may have a static list of predetermined mutually prime numbers to cycle through instead of the zone number generator 320. Further, the display device 302 may include any number of additional components not shown in FIG. 3, depending on the details of the specific implementation. For example, the display device 302 may include various additional smart television functionality.

FIG. 4 is a block diagram showing a tangible, non-transitory, machine-readable storage medium that stores code to direct a processor to generate overlapping numbers of local dimming zones. The machine-readable medium is generally referred to by the reference number 400. The machine-readable medium 400 can include RAM, a hard disk drive, an array of hard disk drives, an optical drive, an array of optical drives, a non-volatile memory, a flash drive, a digital versatile disk (DVD), or a compact disk (CD), among others. The machine-readable storage medium 400 may be accessed by a processor 402 over a bus 404. The processor 402 may be a processor of a display device, such as the processor 304 of FIG. 3. In some examples, the processor 402 may be a field-programmable gate array (FPGA) processor and/or an ASIC processor. Furthermore, as indicated, the machine-readable medium 400 may include code configured to perform the methods and techniques described herein. Indeed, the various logic components discussed herein may be stored on the machine-readable medium 400. Portions 406 and 408 of the machine-readable storage medium 400 can include illuminator module code and zone number generator code, respectively, which may be executable code (machine readable instructions) that direct a processor or controller in performing the techniques discussed with respect to the preceding figures.

Indeed, the various logic (e.g., instructions, code) components discussed herein may be stored on the tangible, non-transitory machine-readable medium 400 as indicated in FIG. 4. For example, the machine-readable medium 400 may include the illuminator module code 406 that, when executed by a processor, direct the processor or a display device to illuminate a liquid crystal display (LCD) using a first number of local dimming zones. In some examples, the illuminator module code 406 may include code to dim the local dimming zones based on the content being displayed at each of the local dimming zones. For examples, local dimming zones containing shadows may be dimmed to reduce the amount of light in the darkest shadows.

The illuminator module code 406 may also include code to illuminate the LCD using a second number of local dimming zones. The illuminator module code 406 may also include code to dim the second number of local dimming zones based on the content being displayed at each of the local dimming zones. The machine-readable medium 400 may also include zone number generator code 408 that when executed by a processor to direct the processor or a display device to generate the first and the second number of local dimming zones. For example, the second number of local dimming zones may be mutually prime with respect to the first number of local dimming zones. In various examples, the zone number generator code 408 may include code to randomly switch to a number of a list of mutually prime numbers. Further, the zone number generator code 408 may include code to periodically switch zone numbers in a predetermined order and a predetermined time interval. In some examples, the zone number generator code 408 may include code to switch to different numbers of local dimming zones based on content to be displayed on the LCD.

Although shown as contiguous blocks, the logic components may be stored in any order or configuration. For example, if the machine-readable medium 400 is a hard drive, the logic components may be stored in non-contiguous, or even overlapping, sectors.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method comprising:
illuminating a liquid crystal display (LCD) using a first number of local dimming zones;
determining a second number of local dimming zones that overlap the first number of local dimming zones; and
illuminating the LCD using the second number of local dimming zones.

2. The method of claim 1, comprising:
determining a series of additional numbers of overlapping local dimming zones; and
illuminating the LCD using the series of additional numbers of overlapping local dimming zones.

3. The method of claim 1, wherein the second number is mutually prime with respect to the first number.

4. The method of claim 1, wherein determining the second number comprises randomly switching to a number of a list of mutually prime numbers.

5. The method of claim 1, comprising periodically switching zone numbers in a predetermined order and a predetermined time interval.

6. The method of claim 1, comprising switching zone numbers based on content to be displayed.

7. The method of claim 1, comprising dynamically changing a brightness of each of the dimming zones to match a brightness level for content appearing in each of the dimming zones.

8. A display device, comprising:
a liquid crystal display (LCD) to be illuminated using a number of local dimming zones;
a zone number generator to generate a series of alternating numbers of overlapping local dimming zones; and
an LCD illuminator to drive a plurality of light emitting diodes (LEDs) of the local dimming zones.

9. The display device of claim 8, wherein each of the local dimming zones comprise a subset of the plurality of LEDs.

10. The display device of claim 8, wherein the alternating numbers of overlapping local dimming zones are mutually prime.

11. The display device of claim 8, wherein the zone number generator is to randomly switch to a number of a list of mutually prime numbers of local dimming zones.

12. The display device of claim 8, wherein the zone number generator is to periodically switching zone numbers in a predetermined order and a predetermined time interval.

13. The display device of claim 8, wherein the zone number generator is to switch to different numbers of local dimming zones based on content to be displayed on the LCD.

14. The display device of claim 8, wherein the LCD illuminator is to dynamically modify a brightness of each of the local dimming zones to match a brightness level for content appearing in each of the local dimming zones.

15. The display device of claim 8, wherein the display device comprises a high dynamic range (HDR) display device.
